(19) United States
(12) Patent Application Publication
(10) Pub. No.: US 2014/0051298 A1
(43) Pub. Date: Feb. 20, 2014

(54) ELECTRICAL CONNECTOR AND ELECTRICAL CONNECTOR ASSEMBLY

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventor: JUN-WEI WANG, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/966,302

(22) Filed: Aug. 14, 2013

(30) Foreign Application Priority Data
Aug. 17, 2012 (CN) 2012102937522

(51) Int. Cl. H01R 13/516

(52) U.S. Cl. CPC H01R 13/516
USPC 439/626

(57) ABSTRACT

A connector assembly includes a male connector and a female connector. The male connector includes a first insulation shell, and a number of first metal terminals received in the first shell. The female connector includes a second insulation shell and a number of second metal terminals received in the second shell. When the male connector is inserted into the female connector, the first metal terminals and the second metal terminals are insulated from static electricity by the first and second insulation shells.

### BACKGROUND

1. Technical Field

The present disclosure relates to electrical connectors and electrical connector assemblies, and particularly to electrical connector assemblies such as universal serial bus (USB) connector assemblies.

2. Description of Related Art

USB connectors are commonly used in electronic devices, such as computers and servers. A USB connector assembly includes a male connector and a female connector. However, because the male connector includes a metal shell, the electronic device may be vulnerable to damage caused by static electricity, and may be vulnerable to malfunctioning caused by electromagnetic interference (EMI).

Therefore, what is needed is a means to overcome the above described shortcomings.

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views.

FIG. 1 is an isometric view of an electrical connector assembly including a male connector and a female connector according to one embodiment, showing the female connector arranged on a circuit board and the two connectors disconnected.

FIG. 2 is an isometric view of the male connector of FIG. 1, but with part of a top wall of a shell thereof omitted, and showing one metal dome thereof.

FIG. 3 is an enlarged, isometric view of the metal dome of FIG. 2.

FIG. 4 is an enlarged, sectional view of a cable connected to the male connector, taken along line IV-IV of FIG. 2.

FIG. 5 is a schematic top view of the male connector and cable of FIG. 2, with top portions thereof cut away to show internal connections.

FIG. 6 is an enlarged, isometric view of the female connector of FIG. 1, showing two metal sheets thereof.

FIG. 7 is an isometric view of one of the metal sheets of FIG. 6.

### DETAILED DESCRIPTION

Reference will be made to the drawings to describe various embodiments.

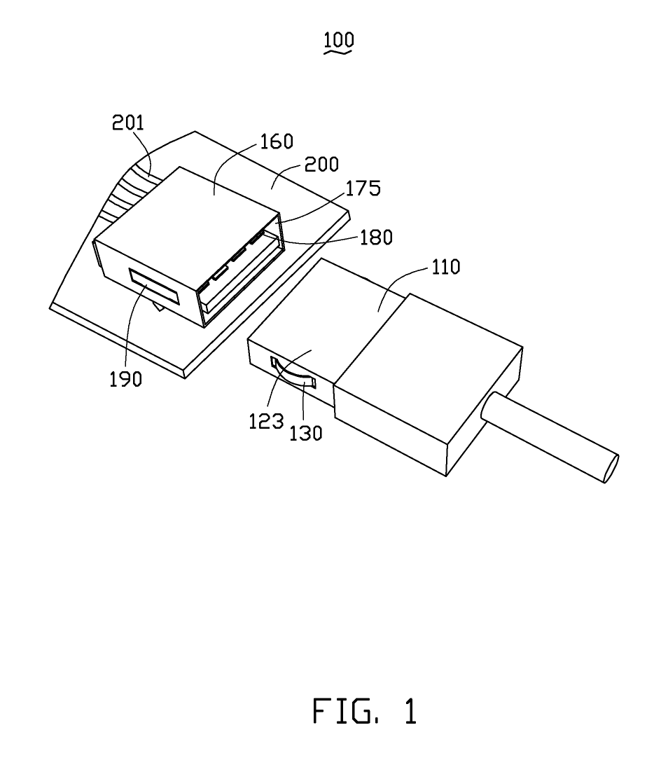

FIG. 1 is an isometric view of an electrical connector assembly 100 including a male connector 110 and a female connector 160 according to one embodiment. In the embodiment, the male connector 110 is a male universal serial bus (USB) connector, and the female connector 160 is a female USB connector compatible with the male connector 110. The female connector 160 is arranged on a circuit board 200 of an electronic device (not shown). The circuit board 200 further includes a plurality of transmission wires 201. One of the transmission wires 201 is grounded.

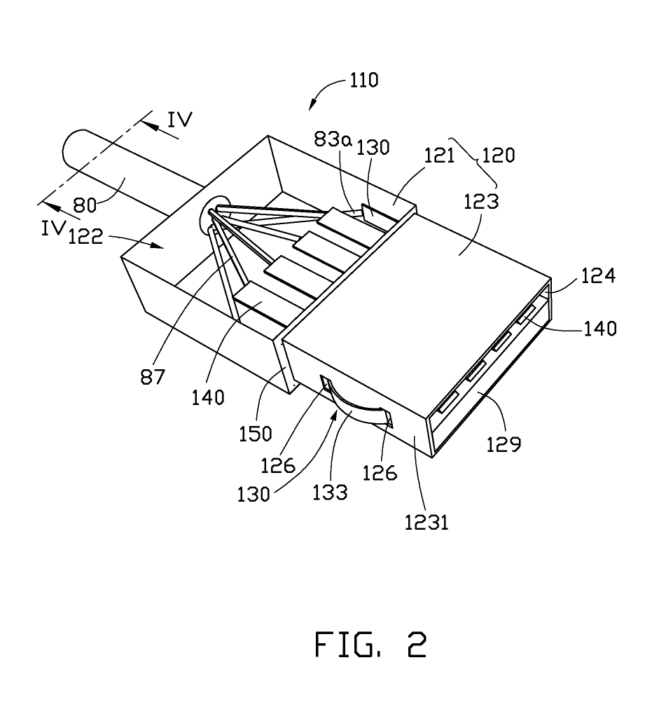

Referring also to FIG. 2, the male connector 110 includes a first shell 120, a supporting portion 129, a pair of metal domes 130, and a plurality of first metal terminals 140. The first metal terminals 140 are received in the first shell 120 and supported by the supporting portion 129. In the embodiment, there are four first metal terminals 140, and the supporting portion 129 is made of electrically insulative material. The metal domes 130 are fixed at two opposite sidewalls 1231 of the first shell 120. Each metal dome 130 includes an elastic bent portion 133 outwardly protruding from an external surface of the corresponding sidewall 1231. In the embodiment, the first shell 120 is made of electrically insulative material.

The first shell 120 includes a first portion 121, and a second portion 123 connected to the first portion 121. The first portion 121 is the part of the male connector 110 that is inserted into the female connector 160. The first portion 121 defines a first receiving space 122 to receive parts of the first metal terminals 140. The second portion 123 defines a second receiving space 124 to receive the other parts of the first metal terminals 140. The first receiving space 122 communicates with the second receiving space 124. A cable 80 passes through an opening located at an end of the first portion 121, to connect to the parts of the first metal terminals 140 received in the first receiving space 122. A transverse cross section of the first portion 121 is slightly larger than a transverse cross section of the second portion 123, to form a four-sided step where the first portion 121 adjoins the second portion 123. The step defines a four-sided resisting surface 150 on the first portion 121 where the first portion 121 adjoins the second portion 123. When the male connector 110 is inserted into the female connector 160, a four-sided front edge of the female connector 160 abuts against the resisting surface 150 of the male connector 110.

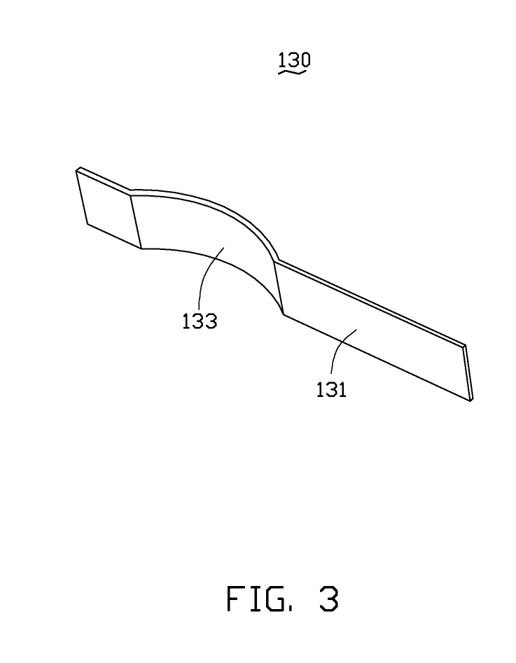

The second portion 123 includes the two opposite sidewalls 1231. Each sidewall 1231 defines two through holes 126. Each metal dome 130 penetrates the corresponding sidewall 1231 via the two through holes 1231. Referring also to FIG. 3, each metal dome 130 includes two fixing portions 131, and the bent portion 133 between the two fixing portions 131. Each fixing portion 131 is plate shaped, and the fixing portions 131 are coplanar. The two fixing portions 131 of each metal dome 130 are fixed on an inner surface of the corresponding sidewall 1231 facing the second receiving space 124. The metal domes 130 are insulated from the first metal terminals 140.

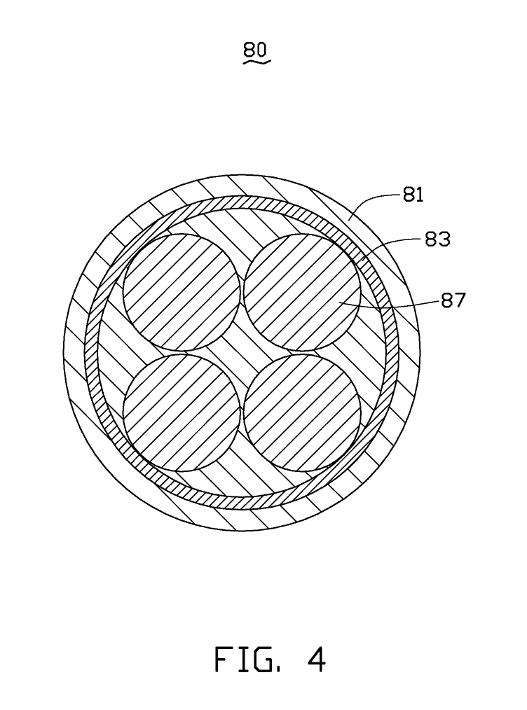

FIG. 4 is a sectional view of the cable 80, which is connected to the male connector 110. The cable 80 includes a protection layer 81, a shielding layer 83, and a plurality of sub-cables 87. The shielding layer 83 surrounds the sub-cables 87 and is grounded to shield against electromagnetic interference (EMI). The protection layer 81 surrounds the shielding layer 83, for protecting the sub-cables 87 and serving as an insulator. In the embodiment, the cable 80 includes four sub-cables 87 configured for connecting to the four first metal terminals 140, respectively.

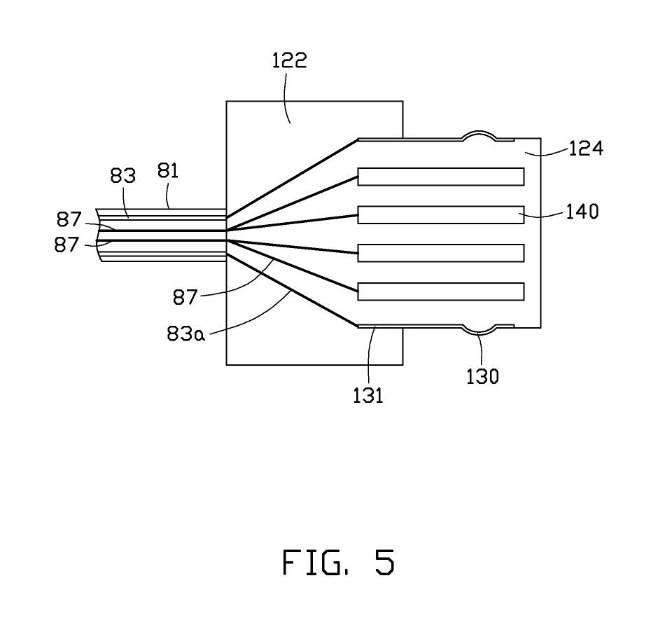

FIG. 5 shows internal connections of the male connector 110. The sub-cables 87 are electrically connected to the first metal terminals 140, respectively. The shielding layer 83 is electrically connected to the nearer one of the fixing portions 131 of each metal dome 130 via a respective shielding wire 83a.

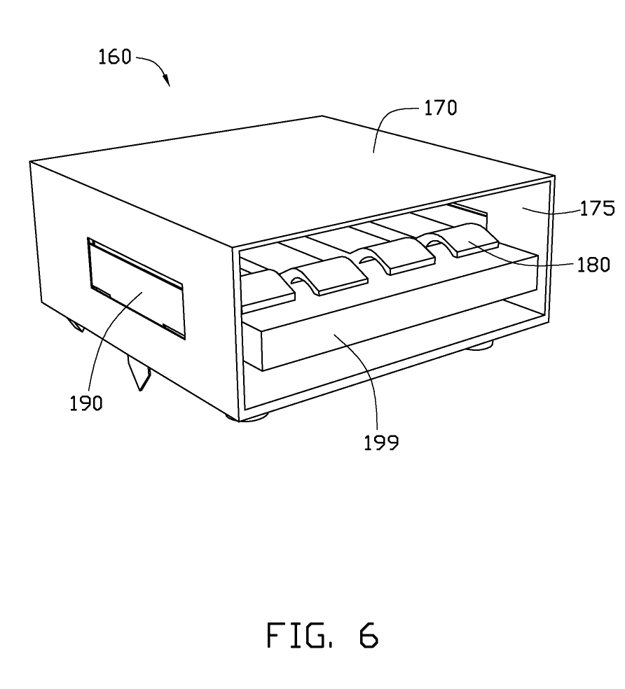

FIG. 6 is an isometric view of the female connector 160. The female connector 160 includes a second shell 170, a plurality of second metal terminals 180, a pair of metal sheets 190, and a second supporting portion 199. The second shell 170 defines a third receiving space 175 to receive the second metal terminals 180. The second metal terminals 180 are supported by the second supporting portion 199. The number of second metal terminals 180 is the same as the number of first metal terminals 140. Thus in the embodiment, there are four second metal terminals 180. The metal sheets 190 are fixed on portions of two opposite sidewalls of the second shell 170, corresponding to the metal domes 130. The metal sheets 190 are insulated from the second metal terminals 180. In the embodiment, the second shell 170 is made of electrically insulative material, and the second supporting portion 199 is likewise made of electrically insulative material.

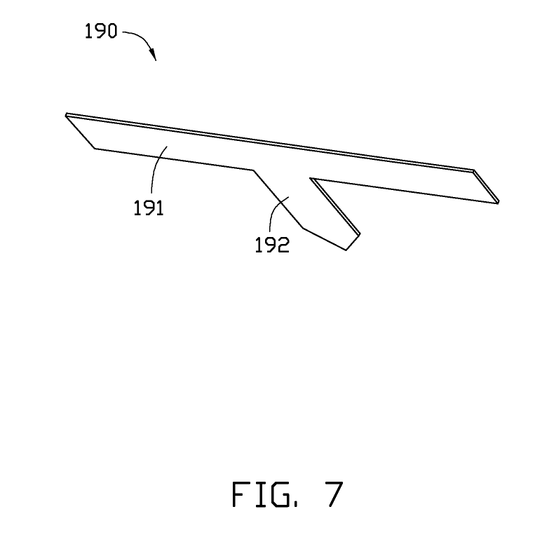

FIG. 7 is an isometric view of one of the metal sheets 190. The metal sheet 190 includes a fixing portion 191 and an extending portion 192. The fixing portion 191 is plate shaped, and fixed on the corresponding sidewall of the second shell 170. The extending portion 192 extends down from the fixing portion 191. In assembly, the extending portion 192 penetrates a bottom wall of the second shell 170, and is grounded via the circuit board 200.

When the male connector 110 is inserted into the female connector 160, the third receiving space 175 receives the second portion 123. Thus, each first metal terminal 140 contacts a corresponding second metal terminal 180 to form a signal transmission channel.

In the above-described embodiments, the first shell 120 and the second shell 170 are both made of insulative material. The first metal terminals 140 are insulated from static electricity by the first shell 120, and the second metal terminals 180 are insulated from static electricity by the second shell 180. Thus, the first terminals 140 and the second metal terminals 180 are not vulnerable to damage by the static electricity, or at least minimally vulnerable.

Furthermore, when the male connector 110 is inserted into the female connector 160, the metal domes 130 contact the metal sheets 190, and thus the shielding layer 83 is grounded via the metal domes 130, the metal sheets 190, and the circuit board 200. Thus a shielding circuit is formed, to shield against electromagnetic radiation that may cause EMI or electronic noise.

It is to be understood that even though numerous characteristics and advantages of the present embodiments have been set forth in the foregoing description, with details of the structures and functions of the embodiments, the disclosure is illustrative only; and changes may be in detail, especially in the matters of shape, size and arrangement of parts within the principles of the embodiments to the full extent indicated by the broad general meaning of the terms in which the appended claims are expressed.

What is claimed is:

1. A connector assembly, comprising:
a male connector comprising:
a first shell made of electrically insulative material;
a first supporting portion received in the first shell; and
a plurality of first metal terminals received in the first shell and supported by the first supporting portion; and
a female connector comprising:
a second shell made of electrically insulative material;
a second supporting portion received in the second shell; and
a plurality of second metal terminals received in the second shell and supported by the second supporting portion;
wherein when the male connector is inserted into the female connector, each second metal terminal contacts a corresponding one of the first metal terminals, and the first metal terminals and the second metal terminals are insulated from static electricity by the first shell and the second shell.

2. The connector assembly of claim 1, wherein the first shell comprises a first portion and a second portion connecting with the first portion, the first portion is inserted into the female connector, the first portion defines a first receiving space receiving parts of the first metal terminals, the second portion defines a second receiving space receiving other parts of the first metal terminals, and the first receiving space communicates with the second receiving space.

3. The connector assembly of claim 2, wherein a transverse cross section of the first portion is larger than a transverse cross section of the second portion to form a four-sided step where the first portion adjoins the second portion, the step defines a resisting surface of the first portion where the first portion adjoins the second portion, and when the male connector is inserted into the female connector, the female connector abuts against the step of the male connector.

4. The connector assembly of claim 2, wherein the male connector further comprises a pair of metal domes fixed at two opposite sidewalls of the first shell, and each metal dome comprises an elastic portion outwardly protruding from an external surface of the sidewall.

5. The connector assembly of claim 4, wherein each sidewall defines two through holes, and each metal dome penetrates the corresponding sidewall via the two through holes.

6. The connector assembly of claim 5, wherein each metal dome further comprises two fixing portions at opposite ends of the elastic portion, respectively, the fixing portions are fixed on a surface of the corresponding sidewall facing the second receiving space, and the metal dome is insulated from the first metal terminals.

7. The connector assembly of claim 6, further comprising a cable connected to the male connector, the cable comprises a shielding layer and a plurality of sub-cables within the shielding layer, each sub-cable is electrically connected to a respective one of the first metal terminals, and the shielding layer is electrically connected to two nearer of the fixing portions of the two metal domes.

8. The connector assembly of claim 6, wherein the fixing portion of each metal dome is plate shaped, and the two fixing portions are coplanar.

9. The connector assembly of claim 1, wherein the female connector further comprises a pair of metal sheets, and the metal sheets are fixed on portions of two opposite sidewalls of the second shell corresponding to the metal domes.

10. The connector assembly of claim 9, wherein the metal sheets are insulated from the second metal terminals.

11. The connector assembly of claim 9, wherein each metal sheet comprises a fixing portion and an extending portion, and the extending portion extends down from the fixing portion and penetrates a bottom wall of the second shell.

12. A male connector, comprising:
a shell made of electrically insulative material;
a supporting portion received in the shell; and
a plurality of metal terminals received in the shell and supported by the supporting portion, wherein the metal terminals are insulated from static electricity by the shell.

13. The male connector of claim 12, wherein the first shell comprises a first portion and a second portion connecting with the first portion, the first portion is inserted into the female connector, the first portion defines a first receiving space receiving parts of the first metal terminals, the second portion defines a second receiving space receiving other parts of the first metal terminals, and the first receiving space communicates with the second receiving space.

14. The male connector of claim 13, wherein a transverse cross section of the first portion is larger than a transverse cross section of the second portion to form a four-sided step where the first portion adjoins the second portion, the step defines a resisting surface of the first portion where the first portion adjoins the second portion, and when the male connector is inserted into the female connector, the female connector abuts against the step of the male connector.

15. The male connector of claim 13, wherein the male connector further comprises a pair of metal domes fixed at two opposite sidewalls of the first shell, and each metal dome comprises an elastic portion outwardly protruding from an external surface of the sidewall.

16. The male connector of claim 15, wherein each sidewall defines two through holes, each metal dome penetrates corresponding sidewall via the two through holes.

17. The male connector of claim 16, wherein each metal dome further comprises two fixing portions at opposite ends of the elastic portion, respectively, the fixing portions are fixed on a surface of the corresponding sidewall facing the second receiving space, and the metal dome is insulated from the first metal terminals.

18. The male connector of claim 16, wherein the male connector connects to a cable, the cable comprises a shielding layer and a plurality of sub-cables within the shielding layer, each sub-cable is electrically connected to a respective one of the first metal terminals, and the shielding layer is electrically connected to two nearer of the fixing portions of the two metal domes.

19. The male connector of claim 16, wherein the fixing portion of each metal dome is plate shaped, and the two fixing portions are coplanar.

20. A female connector, comprising:
a shell made of electrically insulative material;
a supporting portion received in the shell; and
a plurality of metal terminals received in the shell and supported by the supporting portion, wherein the metal terminals are insulated from static electricity by the shell.
